(19) United States
(12) Patent Application Publication
(10) Pub. No.: US 2009/0210483 A1
(43) Pub. Date: Aug. 20, 2009

(54) Systems Methods and Computer Program Products for Remotely Controlling Actions of a Virtual World Identity

(75) Inventors: Justin Pierce, Cary, NC (US); Gregory Dunko, Cary, NC (US); L. Scott Bloebaum, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/048,252

(22) Filed: Mar. 14, 2008

Related U.S. Application Data
(63) Continuation-in-part of application No. 12/032,288, filed on Feb. 15, 2008.

(51) Int. Cl. G06F 15/16

(52) U.S. Cl. 709/203

(57) ABSTRACT

Methods for remotely controlling actions of a virtual world identity of a user include transmitting instructions to the virtual world identity of the user from a mobile terminal associated with a real world identity of the user. The instructions are transmitted as a voice call, a text message and/or an instant message (IM). Updated information associated with the transmitted instructions is received from the virtual world identity of the user at the mobile terminal. The updated information includes an identification of a condition triggering transmission of the updated information.

### CROSS-REFERENCE TO RELATED APPLICATION

This application is a continuation-in-part of, and claims priority to, U.S. patent application Ser. No. 12/032,288 (Attorney Docket: 9314-195), filed Feb. 15, 2008, entitled Systems Methods And User State Files For Enabling Interactions Between Virtual And Real World Identities, the contents of which are incorporated herein by reference.

### FIELD OF THE INVENTION

The present invention relates to electronic devices and, more particularly, to electronic devices, methods and computer program products for use by real and virtual world identities.

### BACKGROUND

The use of electronic devices such as computers and other processor based devices continues to expand. In addition, communication and interaction between such devices is also extensive, using both wireless and wired connections to a world wide network (internet) based on the Internet Protocol (IP).

Various vendors have sought to take advantage of the variety of services offered using this extensive network of connected devices. For example, Apple Corporation has introduced products extending across a “triangle” including portable entertainment devices (iPod/iPhone™); fixed, or at least less-portable, computing device for internet access, collaboration, and content creation (iMac™, PowerBook™); and an internet source for content (iTunes™ for music and videos).

In addition to entertainment uses, such as addressed by Apple Corporation, increasing processor capabilities and memory of server devices coupled to the internet has allowed for the introduction of a variety of “virtual” world environments. Such environments include online gaming environments and the like, where remotely located game participants may participate together in a common game, the state of which game becomes a “virtual“world in which each participant is represented by an “avatar” having a state (e.g., location, armament, health etc.). A variant on such a gaming environment are virtual worlds, such as Second Life® from Linden Labs®. In Second Life®, users may create avatars that may shop, operate businesses, listen to music and the like, while interacting with avatars of other users. It has been proposed that avatars should be provided that may exist in multiple different ones of such virtual worlds. It has further been proposed that virtual mobile terminals should be available for avatars in such virtual worlds that are able to send text messages to recipients in the real world. Thus, such virtual worlds continue to become more sophisticated.

One challenge with virtual worlds, is that users of virtual worlds (e.g. Second Life) are generally disconnected from the virtual world and their avatar when not directly connected to their PC or online with a PC. Many virtual world participants engage in virtual worlds or games where the more, or the longer, users interact with a particular virtual environment, the more experience levels, hit points, or other game-specific benefits can be accrued by that user's avatar (online personality). Further, in many cases, users of the virtual world operate commercial businesses online and would like to actively participate in these commercial interests around the clock and when they are physically offline or away from their PC and/or internet connection. Many owners of stores or commercial interests within the virtual world would like to participate or stay informed of activities and events as they occur in real-time in relation to their virtual world commercial interests while they are offline (at night) or away from their PCs (or internet connection).

### SUMMARY

In some embodiments of the present invention, methods for remotely controlling actions of a virtual world identity of a user include transmitting instructions to the virtual world identity of the user from a mobile terminal associated with a real world identity of the user. The instructions are transmitted as a voice call, a text message and/or an instant message (IM). Updated information associated with the transmitted instructions is received from the virtual world identity of the user at the mobile terminal. The updated information includes an identification of a condition triggering transmission of the updated information.

In other embodiments, the transmitted instructions include an identification of the triggering condition. The triggering condition may be one of a plurality of triggering conditions that are assigned to the virtual world identity of the user by the user. The transmitted instructions may include an identification of a plurality of triggering conditions under which updated information will be provided from the virtual world identity of the user to the mobile terminal, one of which is the condition triggering transmission of the updated information. The plurality of triggering conditions may include detection of a virtual world identity of a second user within a selected proximity of the virtual world identity of the first user. The plurality of triggering conditions may further include detection of a negotiation condition of a sales transaction with a virtual world identity of a second user not anticipated by the transmitted instructions and/or detection of a game decision point for the virtual world identity of the first user not anticipated by the transmitted instructions.

In further embodiments, the updated information includes an identification of a virtual world identity of a second user. Receiving updated information is followed by receiving at the mobile terminal a communication from a communication platform associated with the second user initiated by the virtual world identity of the first user. The communication from the communication platform associated with the second user is a voice call, a text message and/or an instant message (IM).

In other embodiments, receiving updated information is followed by transmitting supplemental instructions to the virtual world identity of the user from the mobile terminal as a voice call, a text message and/or an instant message (IM) responsive to the received updated information. The transmitted instructions and the transmitted supplemental instructions may be transmitted as a voice call and/or a Short Message Service (SMS) text message and the received updated information may be received as a voice call or a Short Message Service (SMS) text message.

In further embodiments, receiving updated information is preceded by the following carried out by the virtual world identity of the user. The transmitted instructions are received. An environment change condition associated with the virtual world identity of the user is detected. The detected environment change is determined to correspond to a triggering condition. The updated information is transmitted to the mobile terminal responsive to determining that the detected environment change corresponds to a triggering condition. Transmitting the updated information may include translating the updated information from a virtual world format to a voice signal and transmitting the updated information as a voice call or translating the updated information from the virtual world format to a Short Message Service (SMS) text message and transmitting the updated information as a Short Message Service (SMS) text message. The updated information may include an identification of a virtual world identity of a second user and determining that the detected environment change corresponds to a triggering condition may be followed by the virtual world identity of the first user establishing a communication connection between a communication platform associated with the second user and the mobile terminal of the first user, the communication connection between the communication platform associated with the second user and the mobile terminal comprising a voice call, a text message and/or an instant message (IM).

In other embodiments, receiving the updated information includes the following carried out automatically by a background application executing on the mobile terminal without input from the user. The user is registered as present to the virtual identity of the user with an IM server. An indication that an IM message for the user is pending is received from the IM server. An application on the mobile terminal that is configured to receive the pending IM message and deliver the pending IM message to the user is activated to provide the updated information to the user.

In yet further embodiments, methods for remotely controlling actions of a virtual world identity of a user include receiving instructions for the virtual world identity of the user from a mobile terminal associated with a real world identity of the user. The instructions are received as a voice call, a text message and/or an instant message (IM). An environment change condition associated with the virtual world identity of the user is detected. The detected environment change is determined to correspond to a triggering condition. Updated information associated with the received instructions is transmitted from the virtual world identity of the user to the mobile terminal responsive to determining that the detected environment change corresponds to a triggering condition. The updated information may include an identification of the condition triggering transmission of the updated information and the received instructions may include an identification of the triggering condition.

In other embodiments, transmitting the updated information is followed by receiving supplemental instructions for the virtual world identity of the user from the mobile terminal as a voice call, a text message and/or an instant message (IM). The received instructions and the received supplemental instructions may be received as a voice call and/or a Short Message Service (SMS) text message and the transmitted updated information may be transmitted as a voice call or a Short Message Service (SMS) text message.

In further embodiments, transmitting the updated information responsive to determining that the detected environment change corresponds to the triggering condition includes translating the updated information from a virtual world format to a voice signal and transmitting the updated information as a voice call or translating the updated information from the virtual world format to a Short Message Service (SMS) text message and transmitting the updated information as a Short Message Service (SMS) text message. The updated information may include an identification of a virtual world identity of a second user and determining that the detected environment change corresponds to a triggering condition may be followed by the virtual world identity of the first user establishing a communication connection between a communication platform associated with the second user and the mobile terminal of the first user. The communication connection between the communication platform associated with the second user and the mobile terminal may be a voice call, a text message and/or an instant message (IM).

In yet further embodiments, methods for remotely controlling actions of a virtual world identity of a user include transmitting instructions to the virtual world identity of the user from a mobile terminal associated with a real world identity of the user as a voice call and/or a Short Message Service (SMS) text message without using an internet connection. Transmitting instructions may be followed by receiving updated information associated with the transmitted instructions from the virtual world identity of the user. The updated information may be a status of completion of the transmitted instructions.

While primarily described above with reference to method aspects, it will be understood that embodiments of the present invention include wireless mobile terminals and computer program products, including computer program code embodied in a computer readable medium, that are configured to carry out the methods of the present invention.

### BRIEF DESCRIPTION OF THE DRAWINGS

FIG. 1 is a schematic diagram of a communication environment supporting real and virtual world identities according to some embodiments of the present invention.

FIG. 2 is a schematic diagram of a user state file according to some embodiments of the present invention.

FIG. 3 is a flowchart illustrating methods for providing a user state file in accordance with some embodiments of the present invention.

FIG. 4 is a flowchart illustrating methods for updating a user state file in accordance with some embodiments of the present invention.

FIG. 5 is a flowchart illustrating methods for updating a user state file in accordance with some embodiments of the present invention.

FIG. 6 is a flowchart illustrating methods for synchronizing user state files across platforms in accordance with some embodiments of the present invention.

FIG. 7 is a flowchart illustrating methods for synchronizing user state files across platforms in accordance with further embodiments of the present invention.

FIG. 8 is a flowchart illustrating methods for enabling interactions between user identities in real and virtual worlds in accordance with some embodiments of the present invention.

FIG. 9 is a flowchart illustrating methods for enabling interactions between user identities in real and virtual worlds in accordance with further embodiments of the present invention.

FIG. 10 is a flowchart illustrating methods for remotely controlling actions of a virtual world identity of a user in accordance with some embodiments of the present invention from the perspective of a user's mobile terminal.

FIG. 11 is a flowchart illustrating methods for remotely controlling actions of a virtual world identity of a user in accordance with further embodiments of the present invention from the perspective of a user's mobile terminal.

FIG. 12 is a flowchart illustrating methods for remotely controlling actions of a virtual world identity of a user in accordance with some embodiments of the present invention from the perspective of a virtual world identity of a user.

FIG. 13 is a flowchart illustrating methods for providing a communication from an avatar to a real-world user in accordance with some embodiments of the present invention.

FIG. 14 is a flowchart illustrating methods for providing a communication from a real-world user to an avatar in accordance with some embodiments of the present invention.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

Well-known functions or constructions may not be described in detail for brevity and/or clarity.

The present invention may be embodied as methods, electronic devices, and/or computer program products. Accordingly, the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store or transport the program for use by or in connection with the instruction execution system, apparatus, or device.

Embodiments according to the present invention are described with reference to block diagrams and/or operational illustrations of methods and communication terminals. In this regard, each block may represent a module, segment, or portion of code, which comprises one or more executable instructions for implementing the specified logical function(s). It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium include the following: hard disks, optical storage devices, magnetic storage devices, a portable computer diskette, a random access memory (RAM), a read-only memory (ROM), an erasable programmable read-only memory (EPROM or Flash memory), and a compact disc read-only memory (CD-ROM).

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminals” may be portable, transportable, installed in a vehicle (aeronautical, maritime, or land-based), or situated and/or configured to operate locally and/or in a distributed fashion at any other location(s) on earth and/or in space.

Some embodiments of the present invention may support a product value “triangle” of mobile terminals, gaming consoles (e.g., Sony Corporation's PS3), and virtual environments for gaming, collaboration, and interaction (e.g., Sony Corporation's Playstation Home and Playstation Network). Systems utilizing mobile terminals and gaming consoles for maintaining unified personal and/or virtual identities and information to be used for interaction in both real and virtual (on-line) environments and methods for the same are provided by some embodiments of the present invention.

Thus, in some embodiments, an individual (user) is able to maintain consistency between his or her identity in both the real and virtual worlds, and is able to communicate and collaborate in both worlds with others having this same capability. In the real world, for example, communication or collaboration may include phone calls, text messages, IM, content sharing, or other forms of communication. Likewise, collaboration in the virtual world may include interaction among avatars in a persistent virtual space (e.g., Second Life or Playstation Home) or engaging in multi-player on-line games of temporary duration, both of which may involve communication between individuals. As will be described herein, both of these may be unified in what will be called a user state file that may include, for example, information about activities, preferences, or transactions (e.g., content purchased) of the individual (“User A”) within both the real and virtual worlds. In addition, for each of a plurality of other users within the individual's sphere (“Users B-Z”), information may be provided about the state of User A's communications with the respective other users. For instance, this state may include a real-world history of calls, text messages, IM's, etc. and virtual-world status of any games being played, transactions contemplated (e.g., Second Life “real estate” purchase), appointments, and the like between User A and each of Users B-Z.

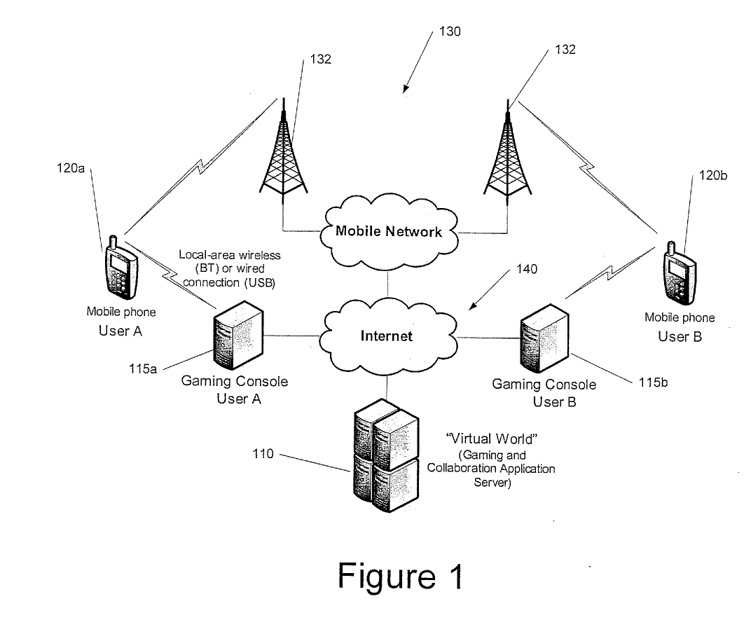

As User A participates, communicates, or collaborates in either the real or the virtual world, his or her user state file may be updated accordingly. As User A encounters new individuals with presence in both worlds, User A may create new entries in their user state file for those individuals. In some embodiments, User A may move his or her user state file among different platforms for communication and collaboration. This is illustrated by reference to the system shown in FIG. 1 below. For instance, User A may have both a mobile phone (mobile terminal) and a gaming console (e.g., Playstation 3). User A may use the mobile phone and network for real-world interaction with User B (e.g., calls or IM's when out and about during the day), but prefers to use the gaming console for virtual-world collaboration and on-line gaming due to its superior capabilities (e.g., when at home later in the evening). When User A wishes to transition to the virtual world, he or she may connect the phone to the gaming console by either a wired or a wireless connection. An application common to both devices may then establish the connection and transfer User A's user state file, updated based on his real-world activities during the day, from the mobile phone into the gaming console. User A may then commence virtual-world activities based on that user state file. When User A is finished in the virtual world, the application may transfer the updated user state file back to the phone, ready to be accessed via the real or virtual world. A master user state file may be stored at a location that is accessible by both real and virtual world associated devices.

Some embodiments of the present invention will now be futher described below with respect to FIGS. 1-9. FIG. 1 is a schematic diagram illustrating a communication environment supporting real and virtual world identities that is configured to enable interactions between virtual and real world identities according to some embodiments of the present invention. As shown in the embodiments of FIG. 1, a first user (User A) has a first platform, shown as mobile terminal 120a, and a second associated platform, shown as a gaming console 115b. A second exemplary user (User B) is shown in FIG. 1 as having a first platform, shown as a mobile terminal 120b, and a second platform, shown as a gaming console 115b. The gaming consoles 115a, 115b are communicatively coupled as schematically illustrated by the wide area network (internet) 140. The mobile terminals 120a, 120b are shown as being communicatively coupled to the wide area network 140 through the mobile network 130, including cellular towers 132.

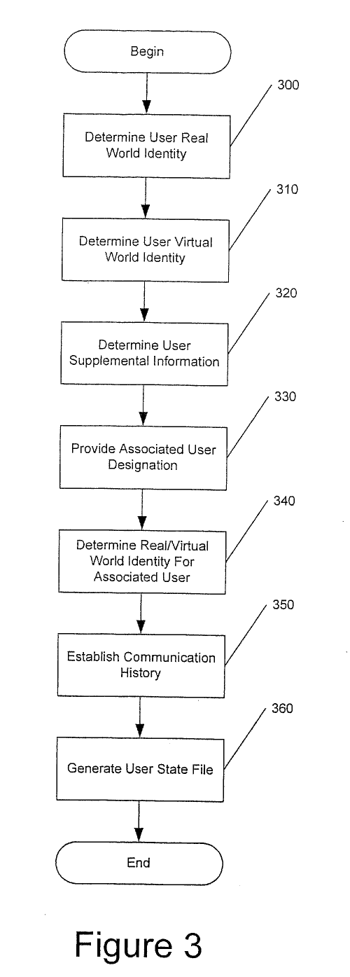

As further seen in the embodiments of FIG. 1, them mobile terminals 120a, 120b may be communicatively connected locally to the respective gaming consoles 115a, 115b. As also shown in FIG. 1, a server 110 is illustrated that is configured to support a virtual world, such as a gaming and/or collaboration application. Operations for enabling interaction between virtual and real world identities of the embodiments illustrated in the communication environment of FIG. 1 will be further described with reference to the flowcharts of FIGS. 3-9.

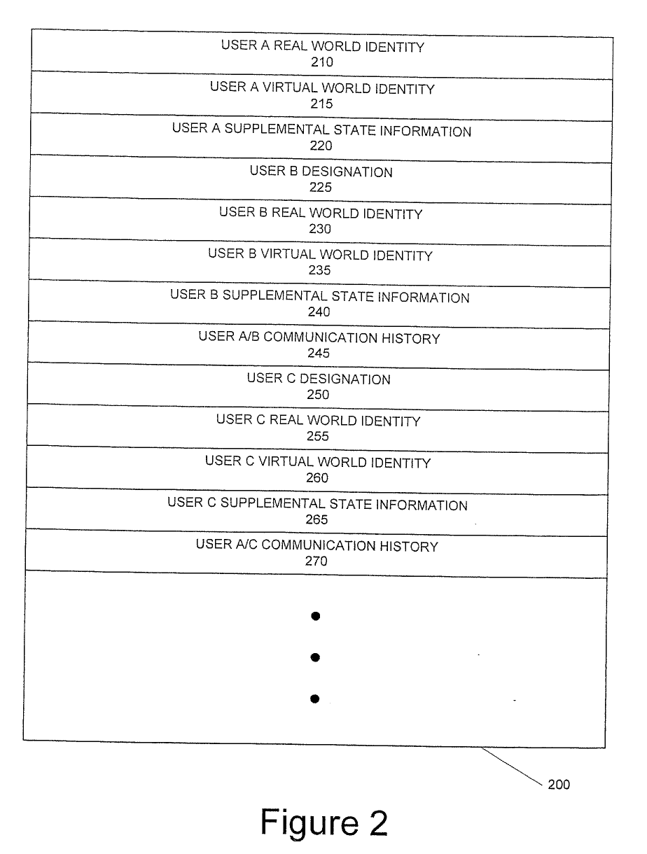

FIG. 2 is a schematic diagram of a user's state file for use in enabling interaction between virtual and real world identities according to some embodiments of the present invention. As shown in the embodiments of FIG. 2, the user's state file 200 includes a real world identity 210 and a virtual world identity 215 associated with a user, (User A). Also shown with respect to User A in the embodiments of FIG. 2 is supplemental state information 220 for User A. Such supplemental state information 220 may include state information not dependent on a communication with another associated user, such as preferences, which supplemental state information 220 may relate to the real world identity and/or the virtual world identity of User A. As described above, the user state file 200 may include information about various other users within User A's personal sphere (i.e., associated with User A in some form in the real world and/or the virtual world). Two such users are illustrated in the user state file 200 in FIG. 2, User B and User C. A real world identity 230, 250 and virtual world identity 235, 255 is shown as stored in the user state file 200 for each of User B and User C. Each of User B and User C further also has supplemental state information 240, 265.

In addition to such described information, which generally corresponds to the type of information described previously with respect to the User A entries 210, 215, 220, for each of the other users within User A's sphere, a communication history 245, 270 is provided including information about the state and history of User A's communications/interactions with the respective users. For example, entries in the communication history 245, 270 may include a real world history of calls, text messages, Is and the like and/or a virtual world status of games being played, transactions contemplated, appointments and the like. The user state file 200 is configured to be accessed by User A in both the real world and the virtual world.

Also shown in the user state file 200 of the embodiments of FIG. 2 is an associated user designation 225, 250 for each of the associated users illustrated in FIG. 2. In the file structure shown in FIG. 2, the user designation 225, 250 may be used to organize storage and retrieval of information with respect to a particular associated user from among a plurality of associated users stored in User A's user state file 200. However, it will be understood that the associated user designation 225, 250 need not be a unique, separately created identification. In other words, a real world identity 230, 255 or virtual world identity 235, 260 for the respective users may also serve as the associated user designation for the respective users. For example, a user having an Avatar named “Hero” may be assigned an associated user designation of “Hero” as well. User A may similarly have a user designation in User A's user state file 200. It will further be understood that, while the user state file 200 includes identification and communications history information in respect to both the real world and the virtual world (or virtual worlds associated with User A), individual ones of the associated users may have identities in the real world, the virtual world or both the real and virtual worlds. Furthermore, a user may have a plurality of identities in each or both of the respective real/virtual worlds. In other words, for example, a user may have an identifier associated with a Playstation gaming scenario and a distinct identification associated with a Second Life® avatar of the respective user.

It will further be understood that the real world identity itself may be an alias so as to protect the privacy of the respective users. In other words, various of the associated users and/or User A may prefer to have their identity remain confidential and may create an alias for use in reference to the respective users in the real world so that the anonymity associated with the avatars in the virtual world will similarly apply to provide privacy in the real world. Conventionally known protocols and procedures restricting access to the information in the user state file 200, the right to obtain and add included information about respective ones of the users included and the like may be applied to control privacy and rights in generation of respective user state files for various users to insure improved access to communications and interactions in a manner that respects the preferences and privacy of the respective users. Details of such control need not be provided herein.

A method for providing a user state file, such as the user state file 200 of FIG. 2, enabling interaction between virtual and real world identities according to some embodiments of the present invention will now be described with reference to the flowchart illustration of FIG. 3. As shown in the embodiments of FIG. 3, operations begin by determining a real world identity of a user (block 300). A virtual world identity is also determined for the user (block 310). In some embodiments, as shown in FIG. 3, supplemental state information associated with the real and/or virtual world identity of the user is also determined (block 320).

An associated user designation is provided for another user associated with the first user (block 330). A real world identity and/or virtual world identity for the associated user is determined (block 340). In addition, a communication history between the first user and the associated user is established (block 350). The communication history established at block 350 includes communications in both the real world and the virtual world.

The user state file 200 is generated based on the information gathered at blocks 300-350 (block 360). More particularly, the user state file 200 generated at block 360 includes information related to both the virtual world and the real world and can be accessed by the first user in both the real world and the virtual world. Thus, a common information resource is provided that may include real world information, such as phone calls, text messages, IM, content sharing or the like as well as information related to collaboration and interaction among avatars in a persistent virtual world and/or interactions in a temporary duration virtual world, such as an on-line multi-player game space. As such, some embodiments of the present invention may provide a unified user state file as illustrated, for example, in FIG. 2. Furthermore, it will be understood that, while operations for generating entries for an associated user are shown at blocks 330-350 for a single associated user, embodiments of the present invention include determining such information for a plurality of associated users and grouping that information in a user state file in block 360. It will be understood, however, that the present invention is not limited to embodiments where the user state file 200 is a single physical file entry on a processor based electronic device but may represent a plurality of distinct files with respect, for example, to different ones of the user, types of information and/or the like so long as the configuration thereof allows access to support operations for enabling interactions between virtual and real world identities as described subsequently herein.

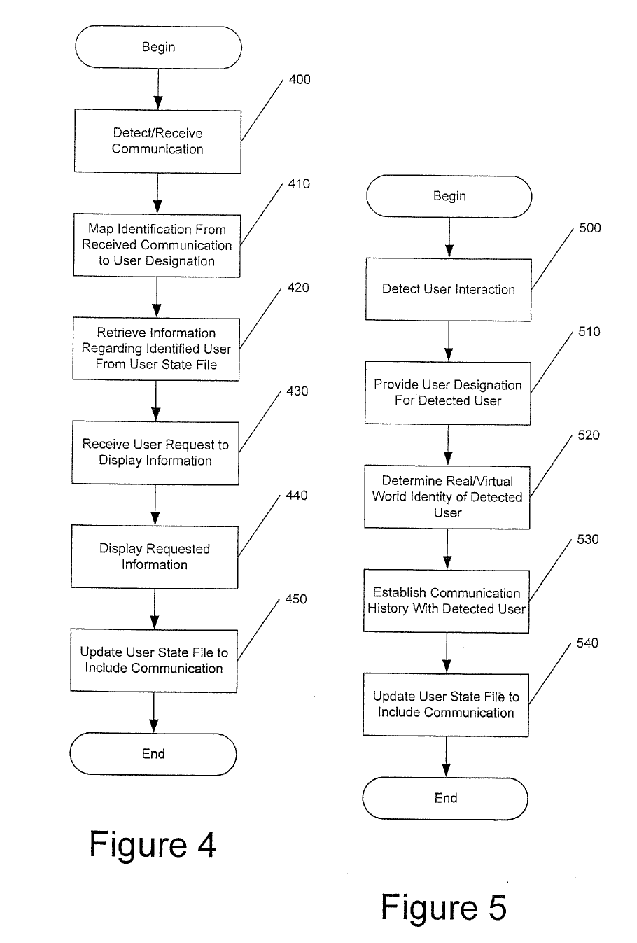

Methods for updating a user state file according to various embodiments of the present invention will now be described with reference to the flowchart illustrations of FIGS. 4 and 5. Referring first to the embodiments of FIG. 4, a communication between a first user and an associated user in the real world and/or virtual world is detected (or received) at block 400. In some embodiments, both real world and virtual world communications are detected/received at block 400. For example, in the real world, a respective communication may be a voice call, a text message or an instant message (IM). In the virtual world, the detected or received communication may be an interaction among avatars associated with the first user and with the associated user in its persistent virtual space and/or may be an engagement between the user and the associated user in an electronic game space of limited time duration. For example, the communication detected in the virtual world may be a virtual world status of a game being played in the game space, a proposed transaction between the avatars in the persistent virtual space, a transaction between the avatars the persistent virtual space, an appointment between avatars in the persistent virtual space and/or the like.

An identification of the associated user from the received communication is mapped to an associated user designation for the associated user (block 410). The real world identity of the associated user, the virtual world of the associated user and/or a communication history between the first user and the associated user is retrieved from the user's state file based on the associated user designation for the associated user (block 420).

For some embodiments, as illustrated in FIG. 4, a request is then received from the first user to display the retrieved information about the associated user from the user state file (block 430). However, it will be understood that the retrieved information may be displayed as a default without awaiting receipt of a request from the first user.

The real world identity of the associated user, the virtual world identity of the associated user and/or the communication history between the user and the associated user is displayed to the first user responsive to the received request from block 430 (block 440). In some embodiments, as also illustrated in FIG. 4, the user state file is updated to include the detected/received communication in the communication history record between the first user and the associated user in the user state file (block 450).

Referring now to the flowchart illustrations of FIG. 5, operations for the illustrated embodiments begin by detecting an interaction between a first user and a second associated user in the real world and/or the virtual world (block 500). An associated user designation is provided for the second associated user (block 510). In other words, as described for the embodiments in FIG. 5, a user having a user state file including a plurality of associated users may identify and add an additional associated user based on interaction experience therewith as will now be further described. Thus, the first user may create new entries in their respective first user state file for newly encountered individuals having roots in either or both real and virtual worlds shared with the first user.

A real world identity and/or a virtual world identity is determined for the new associated user (block 520). In addition, a communication history between the first user and the new associated user is established (block 530). The communication history may include communications in both the real world and the virtual world between the respective users.

As also shown in the embodiments of FIG. 5, the user state file for the first user may then be updated based on the information gathered at block 510-530 (block 540). The updating of the user state file may be triggered responsive to detecting an interaction between the first user and the new associated user at block 500 and the respective ones of the associated users may have their information grouped by their associated user designations. It will be understood that, in some embodiments, the first user may participate in the decision making process used in generating an updated user state file. For example, the user may be given the option to not include a new associated user encountered in the real world and/or virtual world in the user state file.

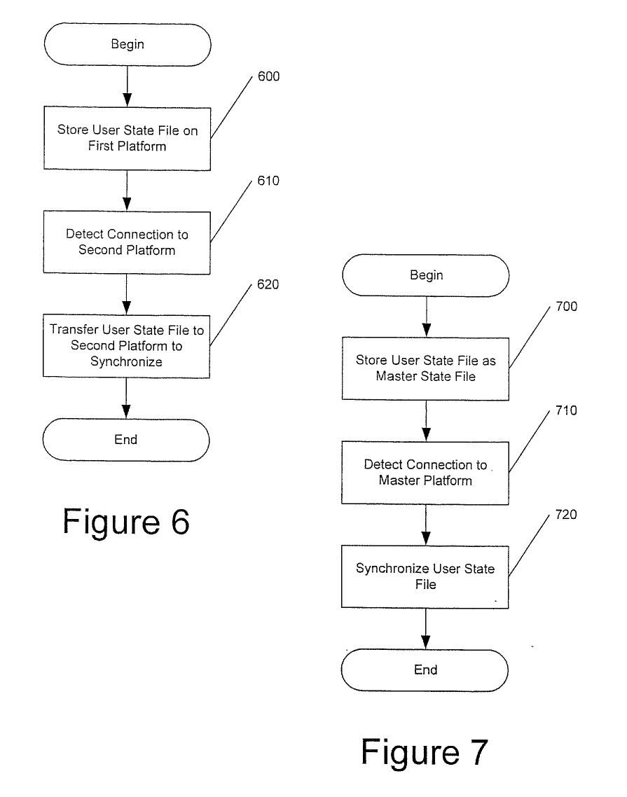

Methods for synchronizing user state files across platforms in accordance with various embodiments of the present invention will now be further described with reference to the flowchart illustrations of FIGS. 6 and 7. The embodiments described with reference to FIG. 6 differ from those in FIG. 7 in that the embodiments of FIG. 7 make use of a master user state file that may be stored remotely from platforms associated with the user, such as the mobile phone 120a and gaming console 115a of FIG. 1. The remotely stored but accessible master user state file may then be accessed by the various platform devices as needed for synchronization purposes. Referring now to FIG. 6, operations begin by storing the user state file on a first platform of the user, such as the mobile terminal 120a (block 600). A communication connection between the first platform and a second platform, such as the gaming console 115a is detected (block 610). For example, as shown in FIG. 1, a local area wireless or wired connection may be established between the mobile terminal 120a and the gaming console 115a. It will be further understood that the first platform, such as the mobile terminal 120a, may be associated with a real world identity of the user while the second platform, such as the gaming console 115a, may be associated with a virtual world identity of the user.

It will be understood that the second terminal may not be a gaming console as illustrated in FIG. 2 and may be, for example, a personal computer, laptop or the like allowing interaction through the internet 140 to a virtual world in which the user has an avatar (identity) supported by the server 110. Similarly, the real world platform may be a personal computer, laptop or the like rather than a mobile terminal as illustrated in FIG. 2. Accordingly, it will be understood that the respective platforms may, in some embodiments, support both virtual and real world interactions rather than being uniquely associated with either the real or the virtual world identity of a user. In any event, as further illustrated for the embodiments of FIG. 6, the user state file is transferred to the second platform to synchronize the user state file with another copy of the user state file already resident on the second platform (block 620). It will be understood that operations at block 620 when referring to first or second platforms may provide synchronization on either or both of the respective platforms.

Further embodiments relating to synchronizing user state files will now be described with reference to the flowchart illustration of FIG. 700. For the embodiments shown in FIG. 700, operations begin by storing the user state file as a master state file on a master platform operatively coupled to the first platform and operatively coupled to one or more other platforms associated with the real or virtual world identity of the users. For example, the master state file could be maintained on a server, such as the server 110 of FIG. 1, and may be communicatively coupled to both the mobile terminal 120a and the gaming console 115a. A communication connection between a platform 120a or the gaming console 115a and a master platform such as the server 110, is detected (block 710). The user state file on the mobile terminal 120a and/or the gaming console 115a is then synchronized with the master user state file (block 720).

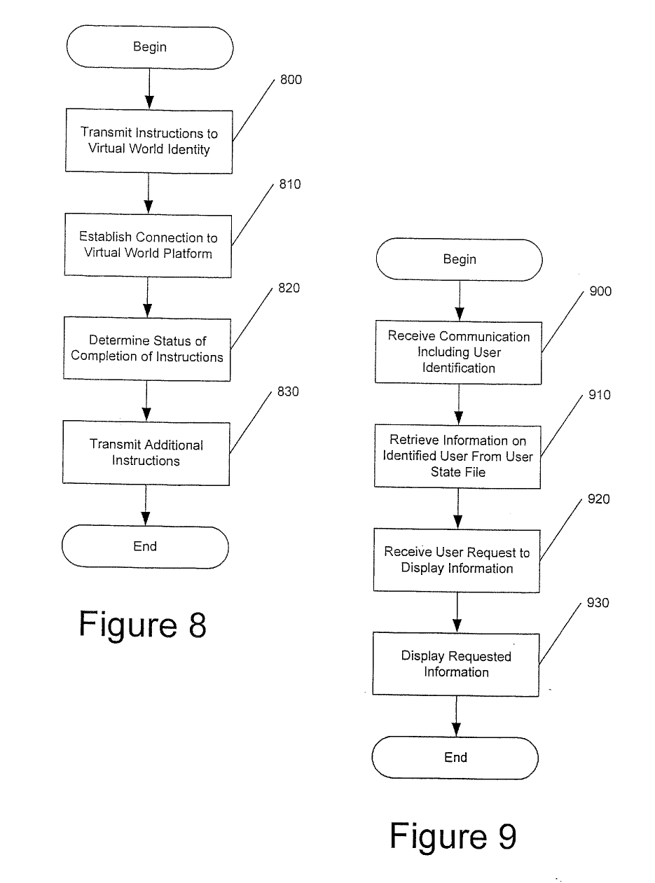

Methods for enabling interactions between user identities in real and virtual worlds in accordance with various embodiments of the present invention will now be described further with reference to the flowchart diagrams of FIGS. 8 and 9. Referring first to the embodiments of FIG. 8, operations begin by transmitting instructions to the virtual world identity of the user from the first platform associated with the real world identity of the user based on the user state file (block 800). In other words, while outside of the virtual world, and in the real world, a user may communicate or send instructions to complete some task or the like to an avatar or virtual identity through a platform, such as the mobile terminal 120a. The instructions may, for example, be sent through the mobile network 130 using short message service (SMS), text messaging, voice and/or the like.

For the embodiments illustrated in FIG. 8, a communication connection may be established from the first platform to a second platform associated with the virtual world identity user (block 810). The status of completion of the transmitted instructions may then be determined based on the user state file (block 820). It will be understood, however, that the first and second platform may be the same platform for monitoring status of instructions where the first platform, such as the mobile terminal 120a, may access a server supporting the virtual world, such as the server 120 through a platform, such as the gaming console 115a or through the mobile network 130, both of which may provide access to the wide area network (internet) 140. Thus, a user could check through the mobile terminal 120a to monitor progress of an instruction, send further instructions and/or the like. Thus, as shown in the embodiments of FIG. 8, additional instructions may be transmitted to the virtual world identity of the user based on the user state file and the determined status of completion of the transmitted instructions (block 830). It will further be understood that, when the user, for example, returns home later in an evening during which interactions have occurred using the mobile terminal 120a, the user may connect the mobile terminal 120a to the gaming console 115a and transition into the virtual world to interact with/through the user's avatar or virtual identity.

Referring now to the embodiments illustrated in FIG. 9, operations begin by receiving a communication in the real world and/or the virtual world (block 900). A received communication includes an identification of a second user. Information regarding the (second) identified user is retrieved (block 910). For example, a real world identity of the second user, a virtual world identity of the second user and/or a communication history between the first user and the second user may be retrieved from a user state file, such as the user state file 200 of FIG. 2.

In the embodiments illustrated in FIG. 9, a request is received from the user to display information about the second user from the user state file (block 920). Retrieved information, such as real world or virtual world identity and/or a communication history between the respective users, is displayed responsive to the received request (block 930). The display may include information about both real world and virtual world interactions (communications) between the respective users as described previously. Thus, as described with respect to various embodiments above, the user state file 200 may support further operations enabling interaction in both real and virtual environments based on unified, real and virtual identities for a user and associated users in a user's real and/or virtual interaction environment.

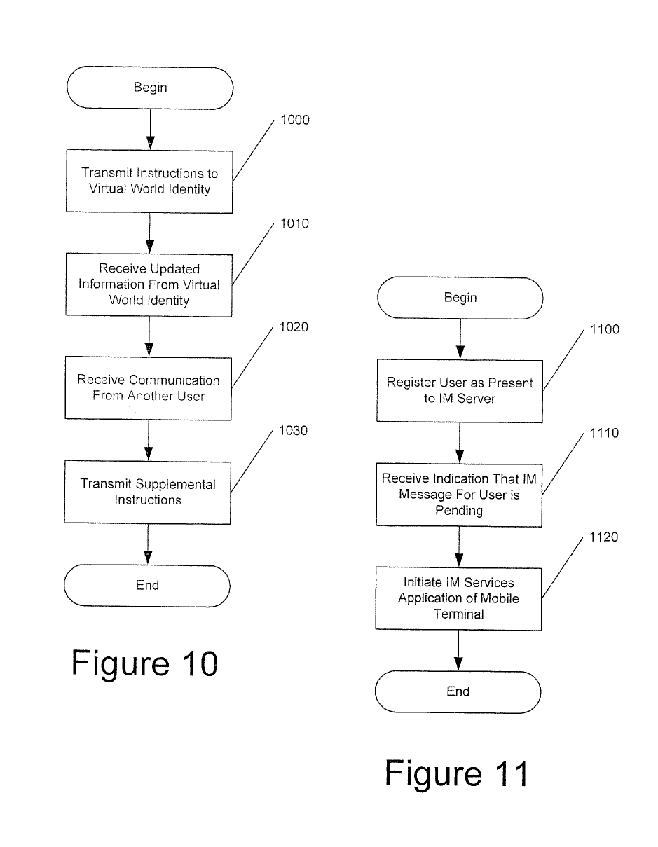

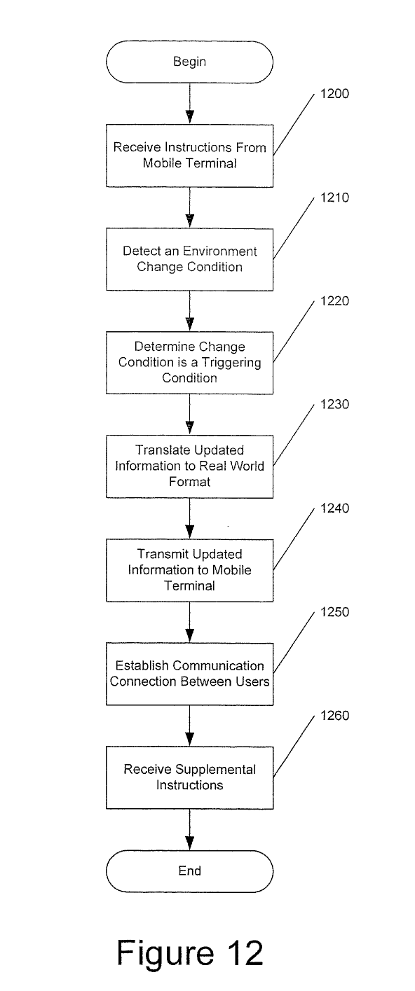

Further embodiments of the present invention will now be further described with reference to FIGS. 10 through 12 wherein messaging between the real world to the virtual world may be used to control the actions of an avatar and/or some aspect of virtual reality and/or messaging from virtual world to real world may be used to inform a user that an avatar has reached a decision point in a virtual environment/scenario/game, and/or that some aspect in a virtual environment that the user is monitoring has changed in some manner. FIG. 10 is a flowchart illustrating methods for remotely controlling actions of a virtual world identity of a user in accordance with some embodiments of the present invention from the perspective of a user's mobile terminal. FIG. 11 is a flowchart illustrating methods for remotely controlling actions of a virtual world identity of a user in accordance with further embodiments of the present invention from the perspective of a user's mobile terminal. FIG. 12 is a flowchart illustrating methods for remotely controlling actions of a virtual world identity of a user in accordance with some embodiments of the present invention from the perspective of a virtual world identity of a user.

For the illustrated embodiments of methods for remotely controlling actions of a virtual world identity of a user seen in FIG. 12, operations begin at Block 1000 by transmitting instructions to the virtual world identity of the user from a mobile terminal associated with a real world identity of the user. For example, User A may use the mobile phone 120a to transmit instructions to a virtual world identity (avatar) of User A on the server 110. The instructions are transmitted at Block 1000 as a voice call, a text message and/or an instant message (IM) using, for example, the cellular tower 132 to access the mobile network 130. As used herein, “remotely” controlling refers to communication with a virtual world identity while not logged into the persistent and/or limited duration virtual space associated with the virtual world identity of the user using a conventional gaming console or computer internet connection. However, it will be understood that the communication, in some embodiments, may be transmitted, at least in part, using an internet protocol based connection.

The transmitted instructions at Block 1000 may include an identification of the triggering condition. In some embodiments, the transmitted instructions include an identification of a plurality of triggering conditions under which updated information will be provided from the virtual world identity of the user to the mobile terminal. The plurality of triggering conditions may have been assigned to the virtual world identity of the user by the user. For example, one of the plurality of triggering conditions may be detection of a virtual world identity of a second user within a selected proximity of the virtual world identity of the first user. In some embodiments, one of the plurality of triggering conditions may be detection of a negotiation condition of a sales transaction with a virtual world identity of a second user not anticipated by the transmitted instructions. For example, the transmitted instructions may tell the virtual world identity to ask for a desired size and color before selling a t-shirt but not have anticipated a customer (second user's virtual world identity) asking for a different style. In other embodiments, the plurality of triggering conditions may include detection of a game decision point for the virtual world identity of the first user not anticipated by the transmitted instructions. For example, the transmitted instructions to a sports team in an online game may not have anticipated a penalty that is called against an opponent during the course of the online game.

Updated information associated with the transmitted instructions is received from the virtual world identity of the user at the mobile terminal, such as the mobile phone 120a (Block 1010). The updated information includes an identification of a condition triggering transmission of the updated information.

In some cases, the triggering condition may indicate that a communication between the user and a second user may be beneficial based on the environmental conditions generating the trigger. For example, a negotiation in a virtual space may benefit from communications between User A and User B, who can be reached at mobile phone 120a and 120b, respectively. As such, in some embodiments the updated information may include an identification of a virtual world identity of a second user (User B). In addition, receiving updated information at Block 1010 may be followed by receiving at the mobile terminal 120a a communication from a communication platform (e.g., mobile phone 120b) associated with the second user (User B) initiated by the virtual world identity of the first user (User A) (Block 1020). The communication from the communication platform associated with the second user may be a voice call, a text message and/or an instant message (IM).

The updated information received at Block 1010 may result in the receiving user (User A) determining additional instructions should be sent to the virtual identity. As such, in some embodiments, receiving updated information at Block 1010 is followed by transmitting supplemental instructions to the virtual world identity of the user (User A) from the mobile terminal (e.g., mobile phone 120a) as a voice call, a text message and/or an instant message (IM) responsive to the received updated information (Block 1030).

In some embodiments the transmitted instructions and the transmitted supplemental instructions are transmitted as a voice call and/or a Short Message Service (SMS) text message. Similarly, the received updated information is received as a voice call or a Short Message Service (SMS) text message. As such, the communications between the virtual world identities and the mobile terminal (e.g., mobile phone 120a) may all be provided without the user of an internet connection.

Referring now to FIG. 11, some embodiments of the present invention will be described wherein an internet connection may be established to support an IM message communication automatically to facilitate a communication from the virtual world identity to the user when the user is not logged on to the virtual space or otherwise engaged in the virtual space with the virtual identity. The operations shown in FIG. 11 are carried out automatically by a background application executing on the mobile terminal (mobile phone 120a) without input from the user (User A). Operations for the illustrated embodiments begin with registering the user as present to the virtual identity of the user with an IM server (Block 1100). The IM server operations may be implemented in the server 110 supporting the virtual space or on another server communicatively coupled to the internet 140. An indication is received that an NM message for the user is pending from the IM server (Block 1110). An application on the mobile terminal that is configured to receive the pending IM message and deliver the pending IM message to the user to provide the updated information to the user is initiated (Block 1120).

A method for remotely controlling actions of a virtual world identity of a user from the perspective of the virtual space according to some embodiments of the present invention will now be described with reference to the flowchart illustration of FIG. 12. For the embodiments of FIG. 12, operations begin at Block 1200 by receiving instructions for the virtual world identity of the user from a mobile terminal associated with a real world identity of the user. The instructions may be received as a voice call, a text message and/or an instant message (IM). In other words, operations at Block 1200 correspond to receiving the instructions transmitted at Block 1000 of FIG. 10.

An environment change condition associated with the virtual world identity of the user is detected (Block 1210). It is determined that the detected environment change corresponds to a triggering condition (Block 1220). The received instructions from Block 1200 may include an identification of the triggering condition identified at Block 1220.

Updated information for transmission will be provided as will be described with reference to Block 1240. In some embodiments, the updated information is first generated in a virtual world format. The updated information may be translated from the virtual world format to a voice signal for transmission at Block 1240 as a voice call (Block 1230). The updated information may be translated from the virtual world format to a Short Message Service (SMS) text message for transmission at Block 1240 as a Short Message Service (SMS) text message (Block 1230).

The updated information associated with the received instructions from the virtual world identity of the user is transmitted to the mobile terminal responsive to determining that the detected environment change corresponds to a triggering condition at Block 1220 (Block 1240). The transmitted updated information may include an identification of the condition triggering transmission of the updated information. In some embodiments, instructions received at Block 1200 may include an identification of the triggering condition.

As discussed previously with reference to Block 1020 of FIG. 10, in some cases it may be desired to establish a direct communication between two users in connection with an environmental condition detected in the virtual space. As such, the virtual world identity of the first user may establish a communication connection between a communication platform associated with the second user and the mobile terminal of the first user (Block 1250). The communication connection between the communication platform associated with the second user and the mobile terminal may be a voice call, a text message and/or an instant message (IM). The updated information transmitted at Block 1240 may include an identification of the virtual world identity of the second user.

In some embodiments, supplemental instructions are also received for the virtual world identity of the user from the mobile terminal (Block 1260). The supplemental instructions may be received as a voice call, a text message and/or an instant message (IM). In some embodiments, the received instructions and the received supplemental instructions are received as a voice call and/or a Short Message Service (SMS) text message and the transmitted updated information is transmitted as a voice call or a Short Message Service (SMS) text message. As such, all the communications may occur without requiring an internet connection between the mobile terminal/communication platform of the real world users and the virtual space.

Methods for remotely controlling actions of a virtual world identity of a user are also provided in which the method includes transmitting instructions to the virtual world identity of the user from a mobile terminal associated with a real world identity of the user. The instructions are transmitted as a voice call and/or a Short Message Service (SMS) text message without using an internet connection. Updated information associated with the transmitted instructions may be received from the virtual world identity of the user. The updated information may include a status of completion of the transmitted instructions.

Some embodiments of the present invention provide wireless mobile terminals configured to carry out the methods described above. In addition, computer program products for remotely controlling actions of a virtual world identity of a user are provided. The computer program products include computer program code embodied in a computer readable medium.

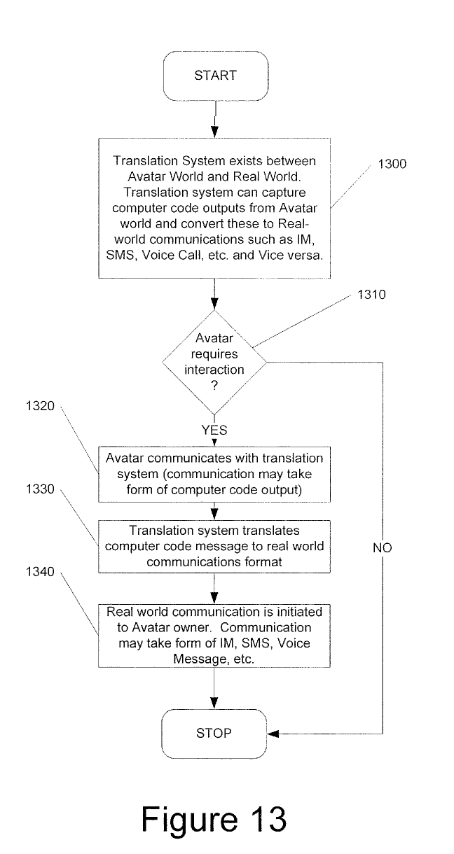

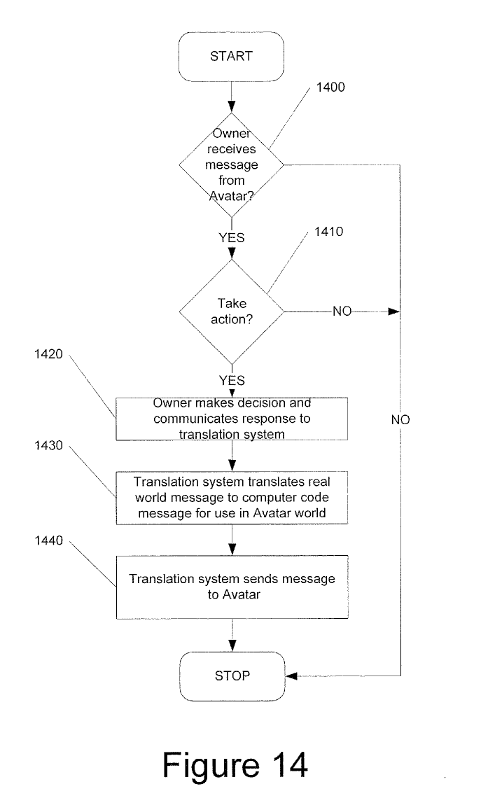

Some embodiments of methods of providing communications between real world and virtual world entities will now be further described with reference to FIGS. 13 and 14. By way of example, such communications could include a user (real world entity/identity, for example, a mobile phone number) transmitting instructions through his mobile phone to his avatar (virtual world entity/identity) through SMS and/or voice message/call (for example, by dialing a particular number associated with the avatar, and then have a program translate the user's voice into text/machine readable code). Upon receipt of the instruction, the avatar could then carry out the task or tasks assigned by the user until a next decision point/environment change is detected by the avatar. In the other direction, virtual world to real world, the avatar, when it reaches a decision point, e.g., when some event occurs in its environment (that the user has pre-defined as important and/or that the avatar recognizes as requiring further instructions), sends an SMS, text message, and/or voice message/call (where the user may actually receive, for example, an automated telephone call from a computer with the voice tone/accent of the user's choosing for his avatar). In this SMS and/or voice call, the avatar may inform the real-world user of its status and/or any environment change updates that the real world user has requested. As discussed above, in some embodiments, the avatar may even facilitate putting the user in touch with the associated real-world user (owner) of another avatar with which the first avatar is interacting (negotiating). For example, if an iterative dialog is needed, the first avatar could facilitate setting up an IM session between the two avatars owners.

FIG. 13 is a flow chart illustrating methods for providing a communication from an avatar to real world user in accordance with some embodiments of the present invention. As shown in the embodiments of FIG. 13, operations at block 1300 with provision of a translation system. More particularly, the translation system is provided between an avatar (virtual) world and the real world. The translation system may be configured to capture computer quote outputs from an avatar world (virtual space) and convert these inputs to real world communications, such as IM messages, SMS text messages, voice calls or the like, or the reverse translation as will be discussed with referenced to FIG. 14.

It is determined that an avatar requires interaction with the real world user (block 1310). If such interaction is required operations continue with the avatar communicating with the translation system, such as in the form of computer code output (block 1320). The translation system translates the computer code message to real world communications format (block 1330). A real world communication is initiated to the user associated with the avatar, which communication may take the form of an IM message, SMS, voice message or the like (block 1340).

FIG. 14 is a flow chart illustrating methods for providing a communication from a real world user to an avatar in accordance with some embodiments of the present invention. For the embodiments illustrated in FIG. 14, operations begin at block 1400 with the owner (a user) receiving a message from an associated avatar. It has been determined if the message requires the owner (user) to take action (block 1410). If action is required (block 1410), operations continue with the owner (user) making a decision and communicating a response to the translation system discussed with reference to block 1300 of FIG. 13 (block 1420). The translation system translates a real world message to a computer code message for use in the avatar world (virtual space) (block 1430). The translation system sends the translated message to the avatar (block 1440).

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method for remotely controlling actions of a virtual world identity of a user, the method comprising:
transmitting instructions to the virtual world identity of the user from a mobile terminal associated with a real world identity of the user as a voice call, a text message and/or an instant message (IM); and
receiving updated information associated with the transmitted instructions from the virtual world identity of the user at the mobile terminal, the updated information including an identification of a condition triggering transmission of the updated information.

2. The method of claim 1, wherein the transmitted instructions include an identification of the triggering condition.

3. The method of claim 1, wherein the transmitted instructions include an identification of a plurality of triggering conditions under which updated information will be provided from the virtual world identity of the user to the mobile terminal and wherein the condition triggering transmission of the updated information comprises one of the plurality of triggering conditions.

4. The method of claim 3, wherein the user comprises a first user and wherein the plurality of triggering conditions includes detection of a virtual world identity of a second user within a selected proximity of the virtual world identity of the first user.

5. The method of claim 3, wherein the user comprises a first user and wherein the plurality of triggering conditions includes detection of a negotiation condition of a sales transaction with a virtual world identity of a second user not anticipated by the transmitted instructions and/or detection of a game decision point for the virtual world identity of the first user not anticipated by the transmitted instructions.

6. The method of claim 1, wherein the user comprises a first user and wherein the updated information includes an identification of a virtual world identity of a second user and wherein receiving updated information is followed by receiving at the mobile terminal a communication from a communication platform associated with the second user initiated by the virtual world identity of the first user, the communication from the communication platform associated with the second user comprising a voice call, a text message and/or an instant message (IM).

7. The method of claim 1, wherein receiving updated information is followed by transmitting supplemental instructions to the virtual world identity of the user from the mobile terminal as a voice call, a text message and/or an instant message (IM) responsive to the received updated information.

8. The method of claim 7, wherein the transmitted instructions and the transmitted supplemental instructions are transmitted as a voice call and/or a Short Message Service (SMS) text message and wherein the received updated information is received as a voice call or a Short Message Service (SMS) text message.

9. The method of claim 1, wherein the triggering condition comprises one of a plurality of triggering conditions that are assigned to the virtual world identity of the user by the user.

10. The method of claim 1, wherein receiving updated information is preceded by the following carried out by the virtual world identity of the user:
receiving the transmitted instructions;
detecting an environment change condition associated with the virtual world identity of the user;
determining that the detected environment change corresponds to a triggering condition; and
transmitting the updated information to the mobile terminal responsive to determining that the detected environment change corresponds to a triggering condition.

11. The method of claim 10, wherein transmitting the updated information responsive to determining that the detected environment change corresponds to the triggering condition includes translating the updated information from a virtual world format to a voice signal and transmitting the updated information as a voice call or translating the updated information from the virtual world format to a Short Message Service (SMS) text message and transmitting the updated information as a Short Message Service (SMS) text message.

12. The method of claim 10, wherein the user comprises a first user and wherein the updated information includes an identification of a virtual world identity of a second user and wherein determining that the detected environment change corresponds to a triggering condition is followed by the virtual world identity of the first user establishing a communication connection between a communication platform associated with the second user and the mobile terminal of the first user, the communication connection between the communication platform associated with the second user and the mobile terminal comprising a voice call, a text message and/or an instant message (IM).

13. The method of claim 1, wherein receiving the updated information comprises the following carried out automatically by a background application executing on the mobile terminal without input from the user:
registering the user as present to the virtual identity of the user with an IM server;
receiving an indication that an IM message for the user is pending from the IM server; and
initiating an application on the mobile terminal that is configured to receive the pending IM message and deliver the pending IM message to the user to provide the updated information to the user.

14. A wireless mobile terminal configured to carry out the method of claim 1.

15. A computer program product for remotely controlling actions of a virtual world identity of a user, the computer program product comprising computer program code embodied in a computer readable medium, the computer program code comprising program code configured to carry out the method of claim 1.

16. A method for remotely controlling actions of a virtual world identity of a user, the method comprising:
receiving instructions for the virtual world identity of the user from a mobile terminal associated with a real world identity of the user as a voice call, a text message and/or an instant message (IM);
detecting an environment change condition associated with the virtual world identity of the user;
determining that the detected environment change corresponds to a triggering condition; and
transmitting updated information associated with the received instructions from the virtual world identity of the user to the mobile terminal responsive to determining that the detected environment change corresponds to a triggering condition.

17. The method of claim 16, wherein the updated information includes an identification of the condition triggering transmission of the updated information.

18. The method of claim 16, wherein the received instructions include an identification of the triggering condition.

19. The method of claim 16, wherein transmitting the updated information is followed by receiving supplemental instructions for the virtual world identity of the user from the mobile terminal as a voice call, a text message and/or an instant message (IM).

20. The method of claim 19, wherein the received instructions and the received supplemental instructions are received as a voice call and/or a Short Message Service (SMS) text message and wherein the transmitted updated information is transmitted as a voice call or a Short Message Service (SMS) text message.

21. The method of claim 16, wherein transmitting the updated information responsive to determining that the detected environment change corresponds to the triggering condition includes translating the updated information from a virtual world format to a voice signal and transmitting the updated information as a voice call or translating the updated information from the virtual world format to a Short Message Service (SMS) text message and transmitting the updated information as a Short Message Service (SMS) text message.

22. The method of claim 16, wherein the user comprises a first user and wherein the updated information includes an identification of a virtual world identity of a second user and wherein determining that the detected environment change corresponds to a triggering condition is followed by the virtual world identity of the first user establishing a communication connection between a communication platform associated with the second user and the mobile terminal of the first user, the communication connection between the communication platform associated with the second user and the mobile terminal comprising a voice call, a text message and/or an instant message (IM).

23. A wireless mobile terminal configured to carry out the method of claim 16.

24. A computer program product for remotely controlling actions of a virtual world identity of a user, the computer program product comprising computer program code embodied in a computer readable medium, the computer program code comprising program code configured to carry out the method of claim 16.

25. A method for remotely controlling actions of a virtual world identity of a user, the method comprising transmitting instructions to the virtual world identity of the user from a mobile terminal associated with a real world identity of the user as a voice call and/or a Short Message Service (SMS) text message without using an internet connection.

26. The method of claim 25, wherein transmitting instructions is followed by receiving updated information associated with the transmitted instructions from the virtual world identity of the user.

27. The method of claim 26, wherein the updated information comprises a status of completion of the transmitted instructions.
